(19) United States
(12) Patent Application Publication
(10) Pub. No.: US 2009/0295650 A1
(43) Pub. Date: Dec. 3, 2009

(54) ANTENNA DEVICE AND WIRELESS COMMUNICATION DEVICE

(75) Inventors: Makoto HIGAKI, Kawasaki-Shi (JP); Kazuhiro INOUE, Inagi-Shi (JP); Tomohiro SUETSUNA, Kawasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/351,235

(22) Filed: Jan. 9, 2009

(30) Foreign Application Priority Data
May 30, 2008 (JP) 2008-142663

(51) Int. Cl. H01Q 1/38; H01Q 1/24

(52) U.S. Cl. 343/702; 343/700 MS

(57) ABSTRACT

An antenna device includes a first dielectric plate; a radiating element formed on a surface of the first dielectric plate; a second dielectric plate; a first conductive plate formed on a surface of the second dielectric plate; and a magnetic plate provided between a back surface of the first dielectric plate and a back surface of the second dielectric plate.

### CROSS REFERENCE TO RELATED APPLICATIONS

This application is based upon and claims the benefit of priority from the prior Japanese Patent Applications No. 2008-142663, filed on May 30, 2008; the entire contents of which are incorporated herein by reference.

### BACKGROUND OF THE INVENTION

The present invention relates to an antenna device and a wireless communication device and, to a technique for band broadening of an antenna, for example.

In a conventional antenna device using a magnetic material, band broadening is achieved by forming antenna patterns on the surface of a magnetic plate (JP-A 2007-124696 (Kokai)).

However, in the above prior art, if a magnetic plate is thin, an antenna device also becomes thin. Accordingly, even when there is a space whose height is sufficiently larger than the thickness of the magnetic plate as a space area in which the antenna device is to be mounted, the distance between an antenna and a conductive ground plate formed on the rear surface of the magnetic plate is short, and the performance of the antenna cannot be sufficiently brought out. Assume that some distance is put between the conductive ground plate and the antenna by leaving a space between a magnetic material and the antenna. In this case, if the permeability of the magnetic material is high, radio waves are reflected by the surface of the magnetic material, and the thickness of the antenna device is substantially equal to the distance between the antenna and the surface of the magnetic material. Thus, even if a space is left between the magnetic material and the antenna, the performance of the antenna cannot be sufficiently brought out.

Plating the surface of a magnetic material with a conductor constituting an antenna or etching a conductor, with which the surface of the magnetic material is plated, may be difficult depending on a magnetic material to be used. It is impossible to fabricate an antenna device using a magnetic material for which the plating or etching is difficult. If a magnetic material has a loss, a current on a conductor (antenna) comes into contact with the magnetic material to be most affected by the loss.

### SUMMARY OF THE INVENTION

According to an aspect of the present invention, there is provided with an antenna device comprising:

a first dielectric plate;

a radiating element formed on a surface of the first dielectric plate;

a second dielectric plate;

a first conductive plate formed on a surface of the second dielectric plate; and

a magnetic plate provided between a back surface of the first dielectric plate and a back surface of the second dielectric plate.

According to an aspect of the present invention, there is provided with a wireless communication device comprising:

said antenna device; and

a radio communication device configured to perform communication through said antenna device.

### BRIEF DESCRIPTION OF THE DRAWINGS

FIGS. 1A and 1B are a perspective view and a side view, respectively, of an antenna device according to a first embodiment;

FIGS. 2A and 2B are a perspective view and a side view, respectively, of an antenna device according to a second embodiment;

FIGS. 3A and 3B are a perspective view and a side view, respectively, of an antenna device according to a third embodiment;

FIGS. 4A and 4B are a perspective view and a side view, respectively, of an antenna device according to a fourth embodiment;

FIGS. 5A and 5B are a perspective view and a side view, respectively, of an antenna device according to a fifth embodiment;

FIGS. 6A and 6B are a perspective view and a side view, respectively, of an antenna device according to a sixth embodiment; and

FIG. 7 is a side view of a wireless communication device according to a seventh embodiment.

### DETAILED DESCRIPTION OF THE INVENTION

Embodiments of the present invention will be described in detail below with reference to the drawings.

### First Embodiment

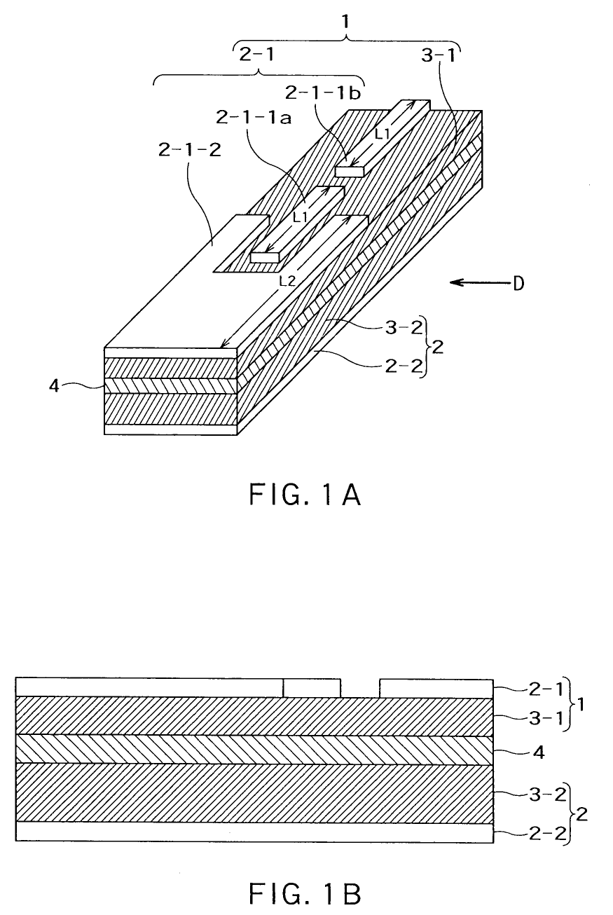

FIGS. 1A and 1B are views of the configuration of an antenna device according to a first embodiment of the present invention. FIG. 1A is a perspective view of the antenna device, and FIG. 1B is a side view of the antenna device seen from a direction “D.”

The antenna device includes a dielectric plate (first dielectric plate) 3-1, conductive plates (conductive patterns) 2-1-1a and 2-1-1b and a conductive plate (second conductive plate) 2-1-2 which are formed on the surface of the dielectric plate 3-1, a dielectric plate (second dielectric plate) 3-2, a conductive plate (first conductive plate) 2-2 which is formed on the surface of the dielectric plate 3-2, and a magnetic plate 4 which is provided between the back surface of the dielectric plate 3-1 and the back surface of the dielectric plate 3-2. The conductive patterns 2-1-1a and 2-1-1b function as radiating elements, and the conductive plate 2-1-2 functions as a passive element.

The conductive plates (conductive patterns) 2-1-1a and 2-1-1b and conductive plate 2-1-2 form a conductive plate layer 2-1, and the conductive plate layer 2-1 and dielectric plate 3-1 form a dielectric substrate 1. The dielectric plate 3-2 and conductive plate 2-2 form a dielectric substrate 2.

The dielectric substrate 1 is obtained by forming a pattern of conductive plates on the surface of the dielectric plate 3-1 by a general substrate processing technique such as etching. More specifically, the conductive patterns 2-1-1a and 2-1-1b and conductive plate 2-1-2 are formed by forming a layer of a conductor across the surface of the dielectric plate 3-1 and patterning the layer of the conductor by the substrate processing technique such as etching.

The conductive patterns 2-1-1a and 2-1-1b, conductive plate 2-1-2, and conductive plate 2-2 each have a small thickness. For example, copper can be used as the material for them. Any material other than copper can be used as long as the material is a high-conductivity material (e.g., gold, silver, any other metal, or conductive plastic).

The dielectric plates 3-1 and 3-2 each have a small thickness and electric characteristics such that a relative dielectric constant is not less than 1 and such that a relative permeability is nearly 1. The electric characteristics of the dielectric plate 3-1 and those of the dielectric plate 3-2 are each equal or approximately equal.

The magnetic plate 4 has electric characteristics such that a relative dielectric constant is not less than 1 and such that a relative permeability is more than 1.

The conductive patterns 2-1-1a and 2-1-1b functioning as the radiating elements each have a belt-like rectangular shape. The conductive patterns 2-1-1a and 2-1-1b have one ends spaced apart from each other by a predetermined distance and are formed in a line (connected through a power supplying unit (not shown)). The conductive patterns 2-1-1a and 2-1-1b have the same pattern length, L1, which is equal to a value obtained by dividing an approximately quarter wavelength at an operating frequency by the square root of the relative dielectric constant of the dielectric plate 3-1 or 3-2. That is, the sum of the pattern lengths of the conductive patterns 2-1-1a and 2-1-1b is equal to a value obtained by dividing an approximately half wavelength at the operating frequency by the square root of the relative dielectric constant of the dielectric plate 3-1 or 3-2. Accordingly, the conductive patterns 2-1-1a and 2-1-1b form a dipole antenna. Although the conductive patterns 2-1-1a and 2-1-1b each have a rectangular shape in this example, they may have any other shape such as a meander shape.

The conductive plate 2-1-2 functioning as the passive element is formed in the vicinity of one end of the dipole antenna (2-1-1a and 2-1-1b) in the longitudinal direction of the dipole antenna separately from the dipole antenna. The conductive plate 2-1-2 has a rectangular shape, and a notch is formed to overlap with the dipole antenna. The conductive plate 2-1-2 and the dipole antenna may be separated from each other in the longitudinal direction of the dipole antenna without forming a notch in the conductive plate 2-1-2. The purpose of arranging the conductive plate 2-1-2 and the dipole antenna to overlap with each other by forming a notch is to reduce the size of the antenna device. A length L2 of the conductive plate 2-1-2 in the longitudinal direction of the dipole antenna (2-1-1a and 2-1-1b) is equal to the value obtained by dividing the approximately half wavelength at the operating frequency by the square root of the relative dielectric constant of the dielectric plate 3-1 or 3-2.

With the above configuration, the operation of the antenna device will be described below.

When a high-frequency voltage is applied to the adjacent one ends of the conductive patterns 2-1-1a and 2-1-1b, the conductive pattern pair 2-1-1a and 2-1-1b operates as a dipole antenna, and the conductive plate 2-1-2 operates as a passive element for increasing the impedance of the dipole antenna. This increases the inductances of the dipole antenna and passive element. Since a bandwidth is proportional to an inductance, the band of the antenna device is broadened. For details, refer to a reference (D. F. Sievenpiper, “High-impedance electromagnetic surfaces,” Ph.D. dissertation, UCLA, 1999).

As described above, according to this embodiment, the dielectric plates are provided on the two surfaces of the magnetic plate, and the conductive plates (conductive patterns) 2-1-1a and 2-1-1b, conductive plate 2-1-2, and conductive plate 2-2 are formed on surfaces of the dielectric plates. With this configuration, even if a thin magnetic material is used, the performance of the antenna can be sufficiently brought out by putting some distance between the antenna and the conductive plate 2-2. That is, it is possible to realize a broadband and high-efficiency antenna device.

According to this embodiment, even if a magnetic material whose surface is difficult to process (a magnetic material in which it is difficult to mount a conductor on a surface) is used, conductive patterns and conductive plates are formed with dielectric plates between them, as described above. It is thus easy to fabricate an antenna device.

Note that although, in this embodiment, the conductive patterns 2-1-1a and 2-1-1b as the radiating elements and the conductive plate 2-1-2 as the passive element are formed on the surface of the dielectric plate 3-1, only the conductive patterns 2-1-1a and 2-1-1b as the radiating elements may be formed without forming the conductive plate 2-1-2. In this case as well, the above advantages of this embodiment can be obtained.

### Second Embodiment

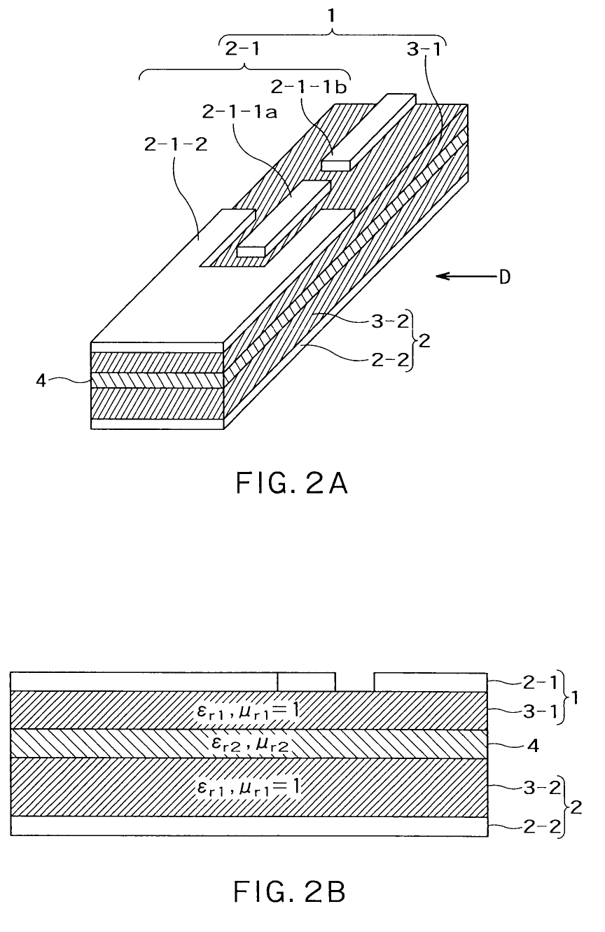

FIGS. 2A and 2B are views of the configuration of an antenna device according to a second embodiment of the present invention. FIG. 2A is a perspective view of the antenna device, and FIG. 2B is a side view of the antenna device seen from a direction “D.” This embodiment is characterized in that the relationship among the relative dielectric constants and relative permeabilities of dielectric plates 3-1 and 3-2 and a magnetic plate 4 is specified. Other configurations are the same as those in the first embodiment, and a redundant description thereof will be omitted.

A relative dielectric constant “εᵣ₁” of the dielectric plates 3-1 and 3-2 is equal or approximately equal to the product of a relative dielectric constant “εᵣ₂” and a relative permeability “μᵣ₂” of the magnetic plate 4 and has an error of, e.g., ±10 percent relative to the product, “εᵣ₂μᵣ₂.” A relative permeability “μᵣ₁” of the dielectric plates 3-1 and 3-2 is nearly 1 (nearly equal to the relative permeability of air).

According to the above configuration, the refractive indices (the square root of relative dielectric constant×relative permeability) of the dielectric plates 3-1 and 3-2 are each equal to or very close to that of the magnetic plate 4. For this reason, radio waves are weakly reflected by each of the interface between the dielectric plate 3-1 and the magnetic plate 4 and that between the dielectric plate 3-2 and the magnetic plate 4. That is, radio waves emitted from an antenna are little reflected by the interfaces and reach a conductive plate 2-2. The antenna operates using the entire thickness. It is thus possible to achieve a broad band and a high degree of efficiency while making full use of a thickness.

### Third Embodiment

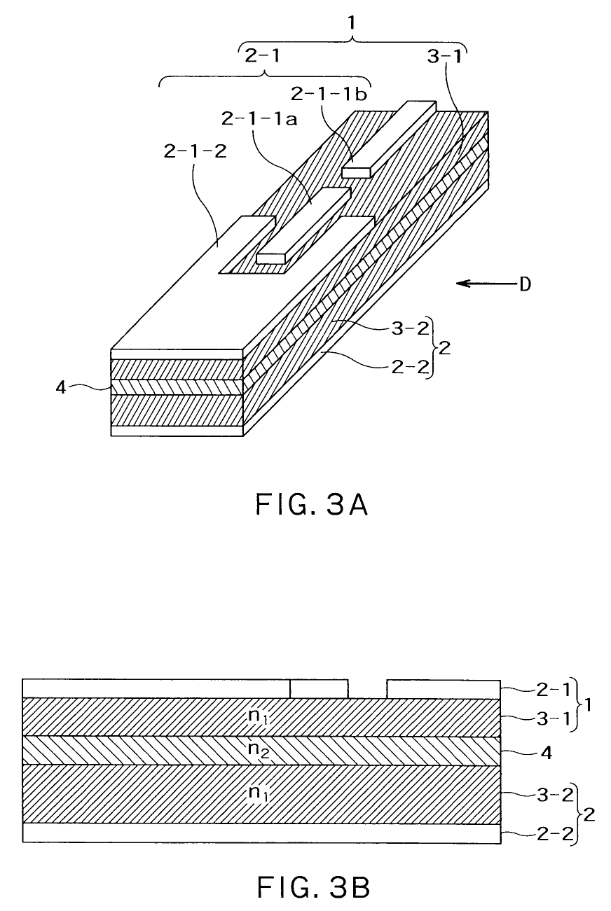

FIGS. 3A and 3B are view of the configuration of an antenna device according to a third embodiment of the present invention. FIG. 3A is a perspective view of the antenna device, and FIG. 3B is a side view of the antenna device seen from a direction “D.” This embodiment is characterized in that the relationship between the refractive indices of dielectric plates 3-1 and 3-2 and that of a magnetic plate 4 is specified. Other configurations are the same as those in the first embodiment, and a redundant description thereof will be omitted.

A refractive index “n₁” of the dielectric plates 3-1 and 3-2 is equal or nearly equal to a refractive index “n₂” of the magnetic plate 4. The dielectric plates 3-1 and 3-2 each have electric characteristics such that the refractive index “n₁” has an error of, e.g., ±10 percent relative to the refractive index “n₂” of a magnetic material.

According to the above configuration, the refractive indices of the dielectric plates 3-1 and 3-2 and that of the magnetic plate are equal or nearly equal to each other. For the same reason as that in the second embodiment, characteristics of a broadband and high-efficiency antenna can be obtained.

### Fourth Embodiment

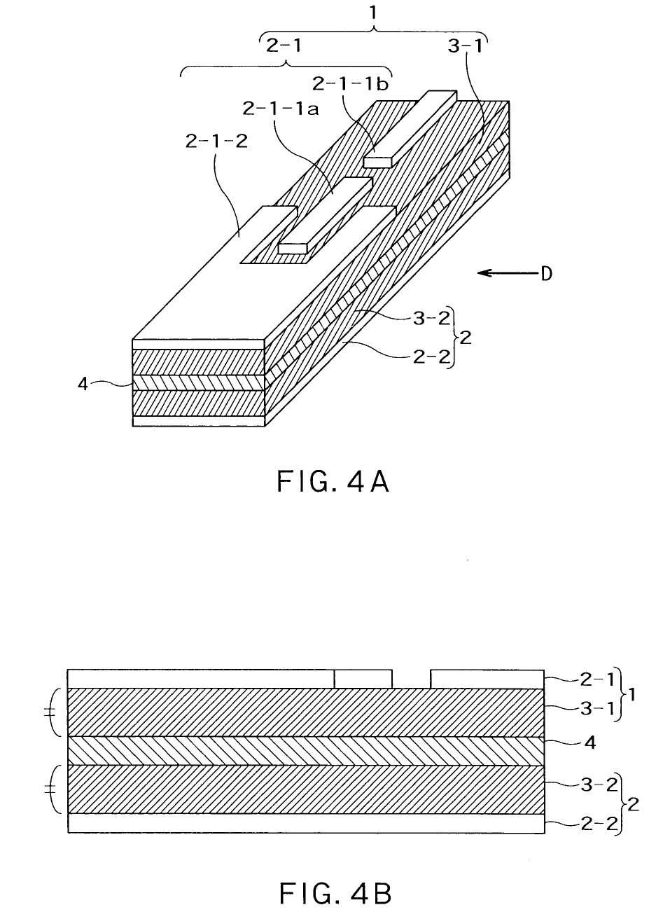

FIGS. 4A and 4B are views of the configuration of an antenna device according to a fourth embodiment of the present invention. FIG. 4A is a perspective view of the antenna device, and FIG. 4B is a side view of the antenna device seen from a direction “D.” This embodiment is characterized in that the relationship between the thicknesses of dielectric plates 3-1 and 3-2 is specified. Other configurations are the same as those in the first embodiment, and a redundant description thereof will be omitted.

The dielectric plates 3-1 and 3-2 each have electric characteristics such that it has a relative dielectric constant which is not less than 1 and a relative permeability which is nearly 1. The thicknesses of the two dielectric plates 3-1 and 3-2 are equal or approximately equal to each other.

A magnetic plate 4 has electric characteristics such that the magnetic plate 4 has a relative dielectric constant which is not less than 1, a relative permeability which is larger than 1, and a magnetic loss tangent tan δ of about several tenths of a percent to 10 percent. Since the thicknesses of the dielectric plates 3-1 and 3-2 are equal, the magnetic plate 4 is arranged at the center or approximately center in a thickness direction.

If a magnetic material has a loss, when a current which generates a strong magnetic field in the vicinity of the current approaches the magnetic material, the current causes a large loss in the magnetic material. In the above configuration, since a magnetic material is arranged at the center or approximately center in the thickness direction, a loss in the magnetic material can be minimized.

As described above, according to this embodiment, the thicknesses of the dielectric plates 3-1 and 3-2 are set to be equal, and the magnetic plate 4 is arranged at the center in the thickness direction. It is thus possible to obtain maximum antenna efficiency.

### Fifth Embodiment

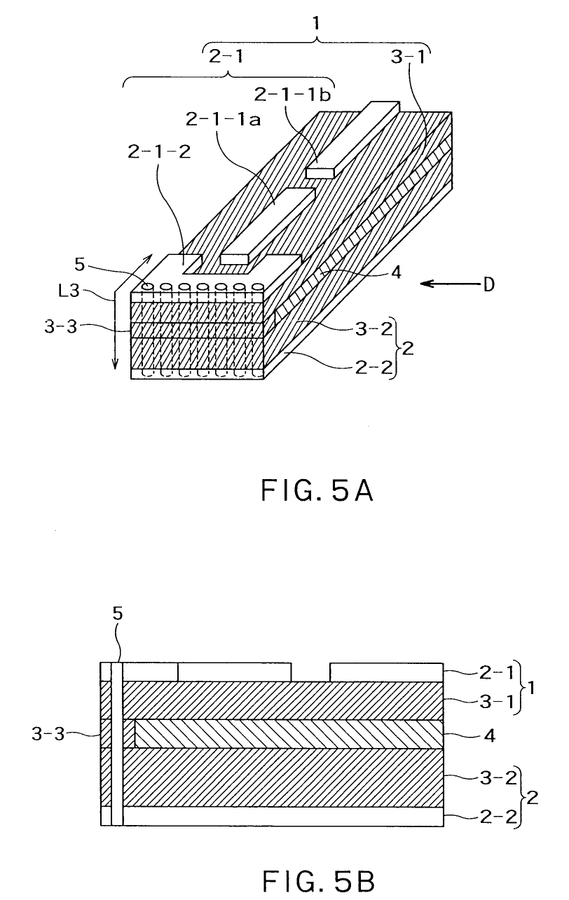

FIGS. 5A and 5B are views of the configuration of an antenna device according to a fifth embodiment of the present invention. FIG. 5A is a perspective view of the antenna device, and FIG. 5B is a side view of the antenna device seen from a direction “D.”

This embodiment is characterized in that the length of a conductive plate (passive element) 2-1-2 in a longitudinal direction is made shorter than those of the conductive plates 2-1-2 in the first to fourth embodiments, and through holes (short circuit portions) 5 which short-circuit an end opposite to a dipole antenna (2-1-1a and 2-1-1b) of the conductive plate 2-1-2 to a conductive plate 2-2 are formed.

The through holes 5 extend through dielectric plates 3-1 and 3-2 and a magnetic plate 4 and short-circuit the conductive plate 2-1-2 to the conductive plate 2-2. Note that a dielectric portion 3-3 made of a dielectric material is formed around positions in the magnetic plate through which the through holes 5 pass. That is, at the time of fabricating the antenna device, the magnetic plate where only the positions through which the through holes pass and a portion around the positions are formed as the dielectric portion made of the dielectric material is prepared, and the through holes are formed to extend through the dielectric portion. This is to allow easy implementation even if through holes are difficult to form in a magnetic plate for the reason that the magnetic plate is breakable or for other reasons. The dielectric portion 3-3 is made of the same material as that for the dielectric plates 3-1 and 3-2 and has the same electric characteristics.

The process of forming the through holes 5 is one of general substrate processing techniques. The through holes 5 are formed by making holes in a substrate and plating the inner wall of each hole with a conductive material. By the through holes 5, the conductive plate 2-1-2 and conductive plate 2-2 are electrically short-circuited. Each hole may be filled with a conductive material instead of plating the inner wall of the hole.

A total length L3 which is the sum of the length of the conductive plate 2-1-2 in the longitudinal direction of the dipole antenna (2-1-1a and 2-1-1b) and the height (length) of the through holes 5 is equal to an approximately quarter wavelength at an operating frequency to be used. That is, the combination of the conductive plate 2-1-2 and the through holes 5 forms a monopole passive element.

Like the second or third embodiment, the refractive indices of the dielectric plates 3-1 and 3-2 and that of the magnetic plate 4 may be set to be equal or approximately equal in order to suppress reflection by an interface.

In this embodiment, the conductive plate 2-1-2 is short-circuited to the conductive plate 2-2 by the through holes 5. Alternatively, the conductive plate 2-1-2 may be short-circuited to the conductive plate 2-2 by forming another conductive plate (short circuit portion) at an end surface (on the front side with respect to the sheet surface) of the antenna device in FIG. 5A.

As described above, according to this embodiment, since the end of the conductive plate 2-1-2 is short-circuited to the conductive plate 2-2 by the through holes, the conductive plate 2-1-2 operates as a monopole passive element which uses the conductive plate 2-2 as a ground plate. Accordingly, a total length which is the sum of the length of the conductive plate 2-1-2 and the height of the through holes may be an approximately quarter wavelength which is a resonant length at an operating frequency to be used. This makes it possible to reduce the size of the antenna device.

At the time of fabricating an antenna device, a magnetic plate where portions through which through holes extend and a portion around the portions are formed as a dielectric portion is used, and through holes extending through the dielectric portion are formed. This allows easy implementation (through hole formation) even if a magnetic plate is breakable. An antenna device with through holes formed in the above-described manner has high durability.

### Sixth Embodiment

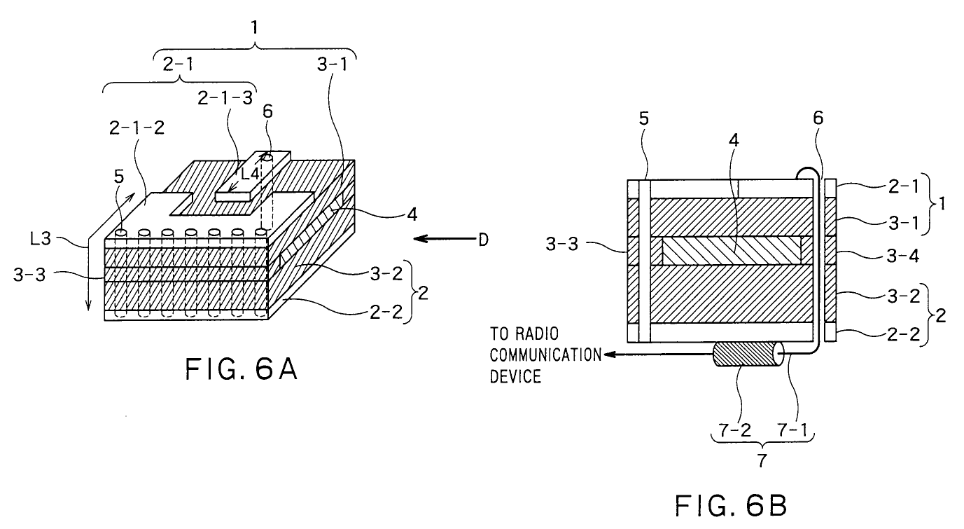

FIGS. 6A and 6B are views of the configuration of an antenna device according to a sixth embodiment of the present invention. FIG. 6A is a perspective view of the antenna device, and FIG. 6B is a side view of the antenna device seen from a direction “D.”

This embodiment is characterized in that a monopole antenna is formed as a radiating element on the surface of a dielectric plate 3-1. More specifically, this embodiment is characterized in that a monopole antenna is formed instead of the dipole antenna in the antenna device according to the fifth embodiment. Differences from the fifth embodiment will be described below.

Only one conductive pattern (conductive plate) 2-1-3 is formed as a radiating element instead of the conductive patterns 2-1-1a and 2-1-1b in the fifth embodiment.

A coaxial line 7 is provided on the side of a conductive plate 2-2 of the antenna device. The coaxial line 7 is a high-frequency line having a linear inner conductor 7-1 and a cylindrical outer conductor 7-2 wrapped around the inner conductor 7-1. Generally, a space between an inner conductor and an outer conductor is often filled with a dielectric in order to maintain the original shape. In this embodiment as well, a space between the inner conductor and the outer conductor is filled with a dielectric.

The outer conductor 7-2 of the coaxial line 7 is short-circuited to the surface of the conductive plate 2-2. That is, the conductive plate 2-2 is connected to a ground. A hole 6 is formed to extend from one end of the conductive plate 2-1-3 (an end on the side opposite to the side where a conductive plate 2-1-2 is arranged) to the conductive plate 2-2. An exposed portion of the inner conductor (feeder) 7-1 of the coaxial line 7 is threaded through the hole 6, and an end of the inner conductor 7-1 is connected to the conductive plate 2-1-3.

A total length which is the sum of the length of an inner conductor portion from the end of the inner conductor 7-1 (or a junction of the inner conductor 7-1 and the conductive plate 2-1-3) to the interface between the conductive plate 2-2 and a dielectric plate 3-2 and a pattern length L4 of the conductive pattern 2-1-3 is an approximately quarter wavelength at an operating frequency to be used. That is, the combination of the above inner conductive portion and the conductive pattern 2-1-3 forms a monopole antenna.

Since the outer conductor 7-2 of the coaxial line 7 is short-circuited to the conductive plate 2-2, the conductive plate 2-2 operates as a ground plate. Power is supplied from the inner conductor 7-1 of the coaxial line 7 to the above monopole antenna.

In a magnetic plate 4, a dielectric portion 3-4 made of a dielectric material is formed around the hole 6. That is, at the time of fabricating the antenna device, the magnetic plate 4 where only a position through which the hole 6 pass and a portion around the position are formed as the dielectric portion made of the dielectric material is prepared, and the hole is formed to extend through the dielectric portion. This is to allow easy implementation even if a hole is difficult to form in a magnetic plate for the reason that the magnetic plate is breakable or for other reasons. The dielectric portion 3-4 is made of the same material as those for the dielectric plates 3-1 and 3-2 and a dielectric portion 3-3 and has the same electric characteristics as those of the dielectric plates 3-1 and 3-2 and the dielectric portion 3-3.

As described above, according to this embodiment, both the conductive pattern 2-1-3 operating as an antenna and the conductive plate 2-1-2 operating as a passive element operate as monopole elements which use the conductive plate 2-2 as a ground plate. This makes it possible to reduce size more than in the fifth embodiment.

At the time of fabricating the antenna device, the magnetic plate where a portion through which the hole 6 extend and a portion around the portion are formed as the dielectric portion is prepared, and the hole extending through the dielectric portion is formed. This allows easy implementation (hole formation) even if a magnetic plate is breakable. An antenna device with a hole formed in the above-described manner has high durability.

### Seventh Embodiment

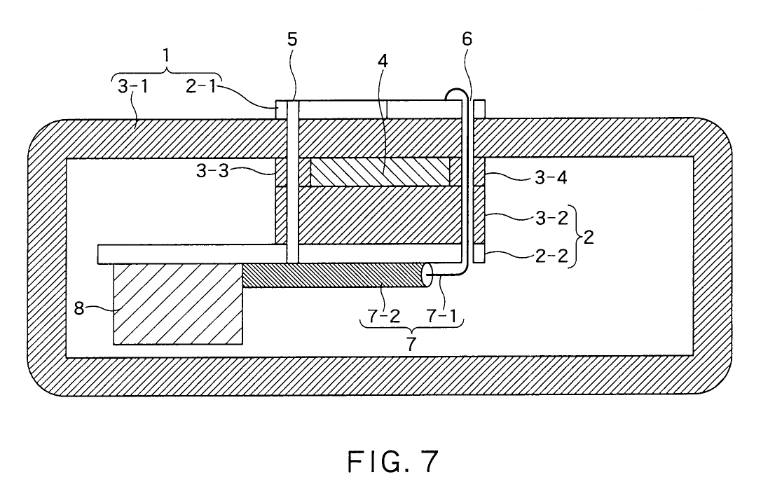

FIG. 7 is a view of the configuration of a wireless communication device according to a seventh embodiment of the present invention. FIG. 7 shows an example of a wireless communication device equipped with the antenna device according to the sixth embodiment (see FIGS. 6A and 6B). The wireless communication device can be provided in, e.g., a piece of mobile communication equipment such as a cellular phone. In FIG. 7, the same components as those in FIGS. 6A and 6B are denoted by the same reference numerals.

A wireless communication device in FIG. 7 includes the antenna device in FIGS. 6A and 6B and a radio communication device 8 which performs wireless communication through the antenna device. A conductive plate 2-2 of the antenna device is extended to the left with respect to the sheet surface of FIG. 7, and the radio communication device 8 is mounted on the surface of an extending portion. The radio communication device 8 generates a high-frequency signal with an operating frequency to be used and supplies the generated signal to an inner conductor 7-1 of a coaxial line 7. The radio communication device 8 receives a high-frequency signal which has been received by the antenna device in FIGS. 6A and 6B operating as an antenna and has been transmitted through the inner conductor 7-1 and performs demodulation and the like. A dielectric plate 3-1 of the antenna device is configured to also serve as a housing of a cellular phone. That is, the antenna device is realized by using a part of a dielectric plate used as a housing of a cellular phone.

A conductive plate layer 2-1 may be formed by forming a conductive layer on the surface of the dielectric plate 3-1 and performing patterning through etching or by applying a conductive material to the surface of the dielectric plate 3-1 through printing.

Although an end of the inner conductor 7-1 is connected to the surface of the conductive layer 2-1 (or more specifically, the surface of a conductive pattern 2-1-3 (see FIGS. 6A and 6B), the end may be pressure-bonded to the rear surface of the conductive layer 2-1 (or more specifically, the rear surface of the conductive pattern 2-1-3) by a pin or the like. In this case, it is, of course, unnecessary to form, in the conductive pattern 2-1-3, a hole through which the inner conductor 7-1 is to be threaded.

As described above, according to the wireless communication device of this embodiment, inclusion of an antenna device according to the present invention makes it possible to perform broadband and high-efficiency wireless communication.

What is claimed is:

1. An antenna device comprising:
a first dielectric plate;
a radiating element formed on a surface of the first dielectric plate;
a second dielectric plate;
a first conductive plate formed on a surface of the second dielectric plate; and
a magnetic plate provided between a back surface of the first dielectric plate and a back surface of the second dielectric plate.

2. The antenna device according to claim 1, wherein
each of relative dielectric constants of the first and second dielectric plates is equal or approximately equal to a product of a relative dielectric constant and a relative permeability of the magnetic plate.

3. The antenna device according to claim 1, wherein
each of refractive indices of the first and second dielectric plates is equal and approximately equal to a refractive index of the magnetic plate.

4. The antenna device according to claim 1, wherein
thicknesses of the first and second dielectric plates are equal and approximately equal to each other.

5. The antenna device according to claim 1, further comprising
a second conductive plate as a passive element which is formed on the surface of the first dielectric plate in a longitudinal direction of the radiating element separately from the radiating element.

6. The antenna device according to claim 5, further comprising
a short circuit portion configured to short-circuit one end of the second conductive plate, which is opposite to the radiating element, to the first conductive plate.

7. The antenna device according to claim 6, wherein
the short circuit portion is a through hole, and
the magnetic plate has a dielectric portion made of a dielectric material around the through hole.

8. The antenna device according to claim 7, wherein
a relative dielectric constant of the first dielectric plate is equal to a relative dielectric constant of the second dielectric plate, and
a total length which is a sum of a length of the second conductive plate in the longitudinal direction of the radiating element and a height of the through hole is approximately equal to a value obtained by dividing an approximately quarter wavelength at an operating frequency by a square root of the relative dielectric constant of one of the first and second dielectric plates.

9. The antenna device according to claim 1, further comprising:
a hole extending through the first and second dielectric plates, magnetic plate, and first conductive plate; and
a feeder which is threaded through the hole and whose one end on the side of the first dielectric plate is connected to the radiating element, wherein
the first conductive plate is connected to a ground.

10. The antenna device according to claim 9, wherein
the magnetic plate has a dielectric portion made of a dielectric material around the hole.

11. The antenna device according to claim 9, wherein
the feeder is a coaxial line having an inner conductor and an outer conductor,
the first conductive plate is short-circuited to the outer conductor of the coaxial line as the ground, and
the inner conductor of the coaxial line is threaded through the hole and connected to the radiating element.

12. The antenna device according claim 9, wherein
a relative dielectric constant of the first dielectric plate is equal to a relative dielectric constant of the second dielectric constant, and
a total length which is a sum of a length of the radiating element and a length of a portion of the feeder from the one end to an interface between the first conductive plate and the second dielectric plate is approximately equal to a value obtained by dividing an approximately quarter wavelength at an operating frequency by a square root of the relative dielectric constant of the one of the first and second dielectric plates.

13. The antenna device according to claim 5, wherein
the relative dielectric constant of the first dielectric plate is equal to the relative dielectric constant of the second dielectric plate, and
a sum of a length of the radiating element and a length of the second conductive plate in the longitudinal direction of the radiating element is approximately equal to a value obtained by dividing an approximately half wavelength at an operating frequency by a square root of the relative dielectric constant of one of the first and second dielectric plates.

14. A wireless communication device comprising:
an antenna device according to claim 1; and
a radio communication device configured to perform communication through the antenna device.
